(19) United States
(12) Patent Application Publication
(10) Pub. No.: US 2002/0143605 A1
(43) Pub. Date: Oct. 3, 2002

(54) Method and apparatus for managing supply and demand in a structured environment

(76) Inventors: Joseph H. Holland, Barrington, IL (US); Mark W. Byrd, Downingtown, PA (US); Kimberly S. Jennings, Fort Collins, CO (US)

Correspondence Address: RATNER AND PRESTIA, Suite 301, One Westlakes, Berwyn, P.O. Box 980, Valley Forge, PA, 19482-0980, US

(21) Appl. No.: 09/820,410

(22) Filed: Mar. 29, 2001

(51) Int. Cl. G06F 17/60

(52) U.S. Cl. 705/10

(57) ABSTRACT

A method for managing output of a resource is taught which includes the steps of a) permitting members of a business community to communicate with a further member of the business community who is a provider of resources; b) initiating, through a plurality of traders who transact business for members within the community, output by the provider; c) projecting the demand of the further members of the community; d) combining the demand projected of the further members of the community; and e) modifying the output of the provider based on combined projected demand.

### FIELD OF THE INVENTION

The present invention relates to a method and apparatus for facilitating the collaboration of multiple members of an exchange in creating and utilizing accurate supply and demand data related to transactions of the multiple members of the exchange.

### BACKGROUND OF THE INVENTION

In recent years, many businesses have found that they can operate more efficiently and with greater profitability by using the Internet to facilitate their operations. An interesting structure which has been used to facilitate interaction between businesses on the Internet is known as an exchange. An example of a type of exchange is a business-to-business(B2B) exchange. In an exchange, multiple companies agree to conduct transactions with each other in a structured Internet environment. Companies that are members of an exchange are thus able to request, offer, sell and buy products and services with each other. Such transactions occur in a structured environment. In many ways, because of the pre-established structure, two companies are able to transact business with each other more efficiently over the exchange than using other communication avenues outside of an exchange.

One reason that exchanges are so useful is because they create vertical markets in which companies can transact business. Thus, each exchange will attempt to play a central role within the market to which it caters. As an exchange grows, it may also reach into other market areas.

All sectors seem to be good candidates for exchange technology. Furthermore, exchanges have helped to increase competition between buyers and sellers, thus leading to reduced prices, higher quality, sharing of information, and lowering of transaction cycles. While exchanges have had phenomenal success, they also suffer from drawbacks. B2B exchanges, for example, may be rigid in the manner in which they are structured. Thus, it may be difficult to add or subtract one or more members from an exchange. Furthermore, it may be difficult to control the transactions between members of an exchange to fine levels of detail.

A critical feature of a transaction-based business, such as the business of a member of an exchange, is the management of the supply and demand of resources. For example, a member of an exchange may supply a product to wholesale customers. In order to meet the customer's demand, the member would like to keep an adequate inventory. Therefore, the member may attempt to project the demand of each of their customers, so that an adequate inventory is maintained.

In order to project the demand of each of the customers, the member may desire to maintain a history of the purchases made by each customer. The member is then able to create a forecast of each customer's future purchases, based on the historical trend of each customer's purchases. The member may also desire to combine the forecasted demand of each customer into a demand forecast for all of the member's customers.

Additionally, the member may desire to track the demand on a product-by-product basis, a market-by-market basis, a seasonal basis, etc. By maintaining the historical records of each customer's demand for each given product, the member may manipulate the customer data and track the demand on whatever basis is appropriate.

Historically, in order to manipulate supply and demand data in this manner, businesses have relied upon accounting and inventory management systems. In recent years, many businesses, including members of exchanges, have relied on spreadsheets to maintain their supply and demand data.

By using a spreadsheet, it is relatively easy to create and or modify a system for supply and demand data manipulation. This is because the spreadsheet programs are in widespread use, and are designed to be user-friendly. Since the data in a spreadsheet can be updated regularly, an exchange member is able to continually manipulate supply and demand data in order to formulate a pro-active business plan.

However, spreadsheet programs are limited in that each spreadsheet is typically custom created for use by each exchange member. As the exchange member may wish to track numerous resources related to management of supply and demand(inventory, sales, accounts, human resource allocation, etc), numerous customized spreadsheets may be required. Additionally, as new business contacts are established by an exchange member, each spreadsheet may need to be updated. Further, since the structure of an exchange is very rigid, updating a spreadsheet based system of supply and demand management is further complicated.

### SUMMARY OF THE INVENTION

The present invention relates to a method and apparatus for providing a plurality of traders in an exchange with data structures which can be created, updated, and utilized by the plurality of traders. The data structures may be used by the plurality of traders to manage supply and demand of critical business resources. The traders transact business for members within a business community.

### BRIEF DESCRIPTION OF THE DRAWINGS

FIG. 1 is a coordinate plane which illustrates the function of an exemplary embodiment of the present invention.

FIG. 2(a) is an illustration of an information exchange in accordance with an exemplary embodiment of the present invention.

FIG. 2(b) is another illustration of an information exchange in accordance with an exemplary embodiment of the present invention.

FIG. 2(c) is yet another illustration of an information exchange in accordance with an exemplary embodiment of the present invention.

FIG. 3 is yet another illustration of an information exchange in accordance with an exemplary embodiment of the present invention.

FIG. 4 is a collaborative data chart in accordance with an exemplary embodiment of the present invention.

FIG. 5 is a flowchart which illustrates a collaborative planning process in accordance with an exemplary embodiment of the present invention.

FIG. 6 is another flowchart which illustrates another collaborative planning process in accordance with an exemplary embodiment of the present invention.

FIG. 7 is a table which illustrates a collaborative planning object in accordance with an exemplary embodiment of the present invention.

FIG. 8 is a table which illustrates a collaborative planning object activity balance in accordance with an exemplary embodiment of the present invention.

FIG. 9 is a table which illustrates a collaborative planning object activity details structure in accordance with an exemplary embodiment of the present invention.

### DETAILED DESCRIPTION OF THE DRAWINGS

The present invention provides an effective mechanism for managing supply and demand related to a plurality of resources in an exchange. In a preferred embodiment, the exchange is a private exchange. An example of a private exchange is a business-to-business (B2B) exchange. Exchanges may be thought of as being comprised of communities in which transactions occur. Each community may be defined in terms of its constituent members. Members transact business with each other through the specific acts of individual traders which act on behalf of their respective members. The structure for the community, member and trader exchanges (hereinafter referred to as “metaprise”) is disclosed in U.S. patent application Ser. No. 09/585,057, which is incorporated herein by reference for its teachings in the art of data processing. Further, a method and apparatus for completing transaction requests within the metaprise structure is disclosed in U.S. patent application Ser. No. 09/707,308, which is also incorporated herein by reference for its teachings in the art of data processing.

Before proceeding, the following definitions may be helpful in order to understand the exemplary embodiments of the present invention.

Member: A member is an organization such as a company or a group. Members transact business with each other if such transaction is authorized. A plurality of attributes for each member are stored in a plurality of databases. Attributes may include, for example, address, form of payment, preferred shipping method, etc.

Community: A plurality of members which are able to transact business with each other form a community. Thus, for example, a community may be given an appropriate name. Members may be allowed to conduct business transactions with each other if they belong to a common community.

Trader: A trader is an individual who performs transactions on behalf of a member. Thus, a trader is an individual who plays a representative role with respect to a member for which that trader performs transactions. An example of a trader is a purchasing agent within a corporation. Another example of a trader individual broker.

Each trader is given specific authorization with regard to his/her ability to interact with other traders, members and communities.

The method disclosed in U.S. patent application Ser. No. 09/585,057 outlines an effective and efficient structure for completing business transactions. However, in a multi-enterprise business environment, such as the metaprise system, numerous businesses need to collaborate on time and quantity based events in order to effectively manage their supply and demand requirements. For example, in order for a wholesale distributor to effectively manage the supply kept in inventory, the distributor will need to have access to the projected demand of each of his/her customers. Therefore, a system is desirable which allows all of the businesses(members/traders) involved to access and update their respective portions of the data structure. While some businesses maintain internal systems to manage their own time and quantity based supply and demand management systems (i.e. manually entering data related to business suppliers and customers into a spreadsheet), there is a need for a system which allows each business participant to access a central collaborative environment in order to view and/or update this data.

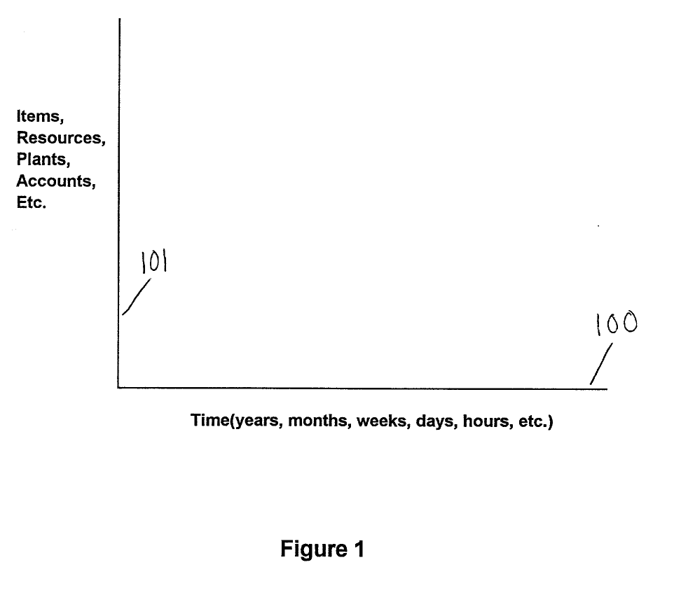

FIG. 1 is a first quadrant of Cartesian coordinate axes which illustrates the management of supply and demand of resources over a period of time, in accordance with an exemplary embodiment of the present invention. The y-axis 101 is a listing of numerous resources. This listing may include products, deliveries, accounts, personnel and any other type of resource. The x-axis 100 is a timeline. The timeline 101 can represent any time period that is appropriate. For example, the timeline 101 could represent a decade, a year, a quarter, a month, a week, a day or an hour. The time period that is included in the timeline (i.e. one year) can be broken down into any appropriate time increments. For example, timeline 101 may represent a time period of one year, and may be broken down into 12 one month increments.

Each point in the first quadrant, defined by y-axis 101 and x-axis 100, represents an intersection of a y-axis 101 resource and an x-axis 100 time period. For example, a point may represent the production of a given product for the first week of the year. A further example is that a point could represent the deliveries of a product that will be made on a particular date. Still a further example is a point which represents a manpower allocation for a particular shift. Essentially, a point could represent any quantity of a y-axis 101 resource for an x-axis 100 time period.

The present invention provides a mechanism to define time period(date, time) and quantity data for a given resource, or a set of resources. This mechanism will hereinafter be referred to as a “collaborative planning object”. Therefore, referring to FIG. 1, an intersection between a y-axis 101 resource (production schedule for a product) and an x-axis 100 time interval (daily, for a month) represents an opportunity to utilize a collaborative planning object. In this example, the collaborative planning object would be the daily production schedule for a month.

The collaborative planning object (CPO) allows the creation of an unlimited number of planning types within a community, and allows for the creation of an unlimited number of planning instances for each planning type. For example, planning types could be production schedules, sales activity, shipment schedules, blanket order release schedules, forecasts, delivery schedules, capacity constraints, optimization constraints, budgets, benchmarks, ROI models, activity based costs, financial and statistical ledgers, inventories, demand aggregation, supply aggregation, load schedules, manpower schedules, etc. Therefore, a planning type can be any allocation of a business resource which can be expressed in terms of a quantity of the resource over a period of time. Further, a planning instance is any time period (and time interval) which is related to the planning types. For example, if the applicable planning type is a delivery schedule, the planning instance under consideration may be the delivery schedule of the product or service for the next 3 months, with a planning instance interval that is daily. Therefore, the planning type (delivery schedule) is created for the next 3 months, broken down into daily delivery schedules.

Referring again to FIG. 1, any one of the y-axis 101 resources could be a planning type for a collaborative planning object. Further, any one of the x-axis 100 time periods could be a planning instance interval for a collaborative planning object.

In order for a member to manage his/her supply and demand in an exchange, the member desirably relies on information from a variety of sources(members/traders). For example, the member may require that each of his/her suppliers of a given product update their production and delivery schedules daily. The collaborative planning object provides a mechanism that traders, associated with members, belonging to communities, can access and update. Therefore, a particular trader may be given access to certain information within a data structure. The collaborative planning object will be updated through accessing the data structure(s). After each trader who is required to update their respective portion of a data structure completes the update, the member who utilizes the collaborative planning object for supply and demand management will be able to retrieve data in a desirable form which the member has been given access to. Accordingly, the member will have the information that he/she needs in order to make business decisions related to the supply and demand of a given resource.

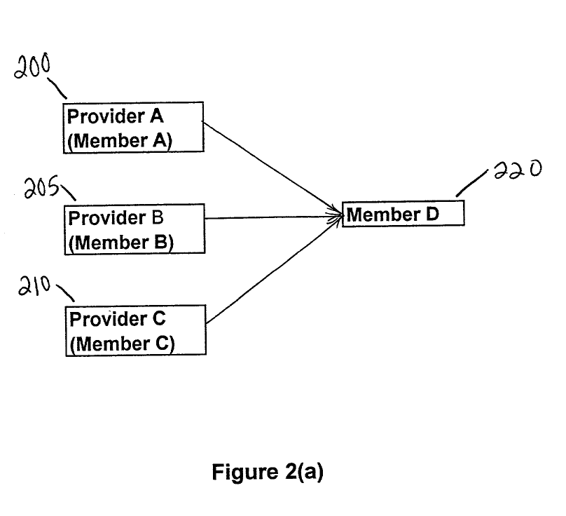

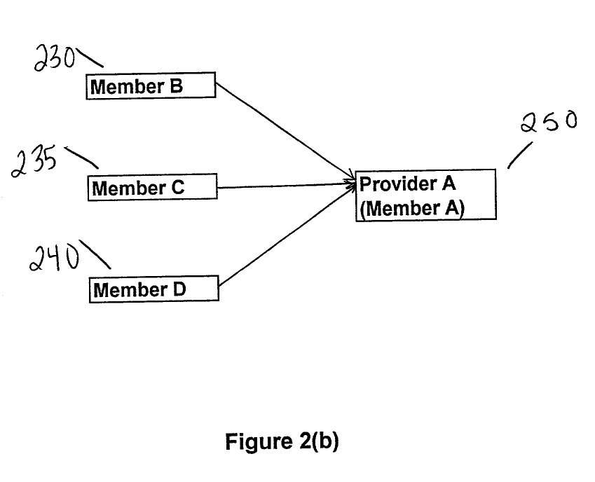

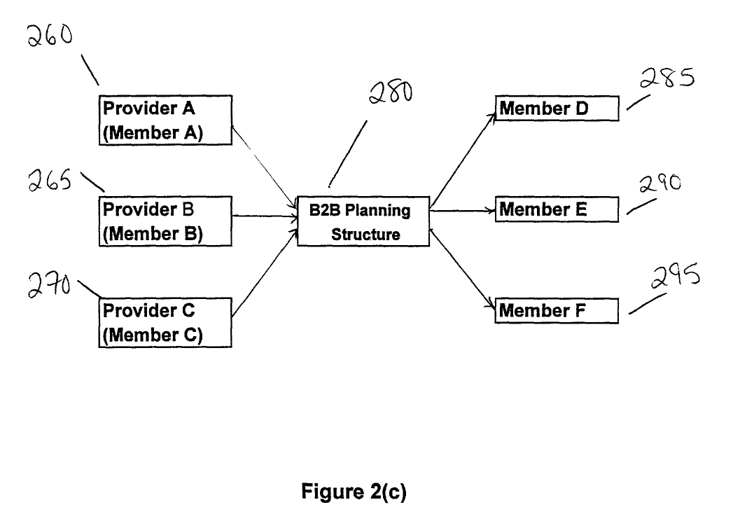

FIG. 2(a) is an example of how a collaborative planning object may be updated. For example, Member D 220 is a retailer who may need to forecast inventory and volume of a given product. However, the product is delivered by three distinct distributors, Provider A 200, Provider B 205 and Provider C 210. Therefore, Member D requires that Provider A 200, Provider B 205 and Provider C 210 each update a respective delivery schedule (related to a collaborative planning object) on a certain time incremented basis. After each of the providers has updated a respective delivery schedule, Member D is now able to forecast the production of the product by accessing the collaborative planning object related to the component delivery schedules provided by Provider A 200, Provider B 205 and Provider C 210.

In some situations, each member who updates a data structure (or a part of a data structure) related to a collaborative planning object is the only trader/member who has access to that given area of the data structure. Therefore, numerous traders/members could not access and update the same data. In other situations, multiple traders/members may have access to the same area of a data structure. As such, there is the possibility that multiple members may attempt to access and update the same data at the same time. Typically, the first user to access the partitioned area of the data structure is given access to update the data structure, while subsequent users are unaware that such access has been given. Therefore, a subsequent user will not know that the data has been updated until the first user has completed his/her update and the subsequent user tries to view that data.

Conversely, FIG. 2(b) is another example of how a collaborative planning object may be updated. For example, Provider A 250 (Member A) may be a manufacturer who produces a given product. As such, Provider A 250 may need to create a production schedule for the next six months for the given product. In order to manufacture the product, however, Provider A 250 needs three distinct components. The first component is supplied to Provider A 250 by Member B 230. The second component is supplied to Provider A 250 by Member C 235. The third component is supplied to Provider A 250 by Member D 240. In order to create a production schedule for the product, Provider A 250 will need to obtain delivery data for each of the three components from Member B 230, Member C 235 and Member D 240. In the exemplary embodiment of the collaborative planning object illustrated in FIG. 2(b), Member B 230, Member C 235 and Member D 240 each update a portion of the delivery schedule (related to a collaborative planning object). Therefore, Provider A is now able to retrieve the data in the form of a collaborative planning object for each of the components for the six month period.

A further exemplary embodiment of the present invention is illustrated in FIG. 2(c). Member D 285, Member E 290 and Member F 295 each require delivery information from numerous providers. Provider A(Member A), Provider B(Member B) and Provider C(Member C) each update respective delivery data by transmitting the revised data to the B2B Planning Structure 280 (related to a collaborative planning object). After the B2B Planning Structure 280 had been updated by each of the providers, then Member D 285, Member E 290 and Member F 295 can each utilize the collaborative planning object related to the data they desire. For example, Member D can project the inventory that he will have for a certain time period for each of the products provided by Provider A(Member A), Provider B(Member B) and Provider C(Member C).

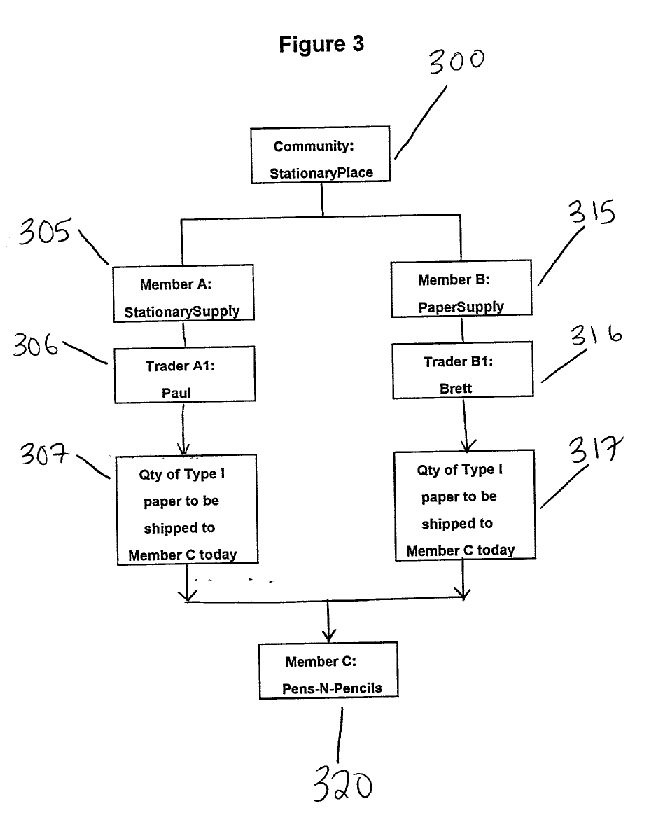

FIG. 3 illustrates another exemplary embodiment of the present invention. The community illustrated in FIG. 3 is StationaryPlace 300. StationaryPlace 300 includes Member A 305 (StationarySupply), which is a stationary supply distributor. StationaryPlace 300 also includes Member B 315 (PaperSupply), which is also a stationary supply distributor. Trader A1 306 (Paul) is associated with Member A 305 (StationarySupply). Trader B1 316 (Brett) is associated with Member B 315 (PaperSupply). StationaryPlace 300 also includes Member C 320 (Pens-N-Pencils) which is a stationary retailer. Within StationaryPlace 300, Member A 305 (StationarySupply) and Member B 315 (PaperSupply) both supply stationary to includes Member C 320 (Pens-N-Pencils). One item that both Member A 305 (StationarySupply) and Member B 315 (PaperSupply) supply to Member C 320 (Pens-N-Pencils) is Type I paper. In order to make business decisions related to his stock of Type I paper, Member C 320 (Pens-N-Pencils) would like to know his/her receiving schedule for Type I paper from both of the suppliers. Member C 320 (Pens-N-Pencils) would like to have access to a collaborative planning object which represents his/her receiving schedule for Type I paper for the next year, in one month increments. In order for such a collaborative planning object to be created, both Member A 305 (StationarySupply) and Member B 315 (PaperSupply) would have to transmit their delivery data to a data structure which utilizes the data to create the collaborative planning object desired by Member C 320 (Pens-N-Pencils).

Therefore, as shown in the exemplary embodiment of FIG. 3, Trader A1 306 (Paul), doing business on behalf of Member A 305 (StationarySupply), transmits his/her daily shipment of Type I paper to Member C 320 (Pens-N-Pencils) at 307. Further, Trader B 1 316 (Brett), doing business on behalf of Member B 315 (PaperSupply), transmits his/her daily shipment of Type I paper to Member C 320 (Pens-N-Pencils) at 317. Member C 320 (Pens-N-Pencils) will have access to a collaborative planning object which utilizes a data structure to obtain the updated delivery data transmitted by both Trader A1 306 (Paul) and Trader B 1 316 (Brett). Member C 320 (Pens-N-Pencils) can now analyze his/her receiving schedule for Type I paper, and make business decisions accordingly.

Although FIG. 3 shows that Trader A1 306 (Paul) and Trader B 1 316 (Brett) transmit the delivery data directly to Member C 320 (Pens-N-Pencils), this is simply an example of how the data transmission can take place. The data could be transmitted in any number of ways known in the art, so long as the data is partitioned such that a given member or trader only has access to a certain portion of the data, determined by his/her identity within the community. For example, Trader A1 306 (Paul) and Trader B 1 316 (Brett) could transmit the delivery data to a common data structure for the community StationaryPlace 300. Therefore, different members within StationaryPlace 300 would have access to different areas of the same common data structure, and as such, Trader A1 306 (Paul) and Trader B1 316 (Brett) would have access to a respective portion of the data structure which would allow them to enter delivery data to customers, such as Member C 320 (Pens-N-Pencils). Further, Member C 320 (Pens-N-Pencils) would have access to a respective portion of the common data structure such that Member C 320 (Pens-N-Pencils) can view and manipulate the receiving data from all of their suppliers.

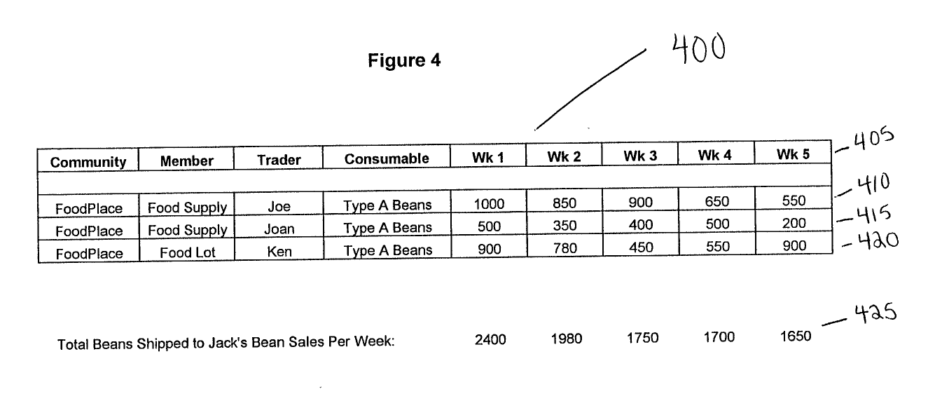

FIG. 4 is a table which illustrates another example of a collaborative planning object, or a data structure related to a collaborative planning object. Table 400 represents a collaborative planning object which includes the delivery of a consumable (Type A Beans) from each of a group of suppliers to the retailer, Jack. Table 400 includes header line 405. Header line 405 provides the categories of information included in the collaborative planning object. Header line 405 includes the categories of community, member, trader, consumable, and a listing of week 1 through week 5. Weeks 1 through week 5 represents the time period for which Jack is interested in monitoring his Type A Bean receipts. FIG. 4 indicates that Jack has 3 different suppliers of Type A Beans during the time period of week 1 through week 5. The three different suppliers, and the delivery information for each of weeks 1 through week 5, is included in text lines 410, 415 and 420.

Text line 410 indicates that the community is FoodPlace, and the member involved is Food Supply. Trader Joe transacts business on behalf of Food Supply. The consumable involved in the transaction is Type A Beans. Further, the quantities of Type A Beans that Joe has shipped (or forecasts shipping) to Jack are listed under the header line categories of week 1 through week 5. As such, Joe has shipped (or forecasts shipping) 1000 pounds of beans in week 1, 850 pounds of beans in week 2, 900 pounds of beans in week 3, 650 pounds of beans in week 4, and 550 pounds of beans in week 5.

Text line 415 indicates that the community is FoodPlace, and the member involved is again Food Supply. Trader Joan transacts business on behalf of Food Supply. The consumable involved in the transaction is Type A Beans. Further, the quantities of Type A Beans that Joan has shipped (or forecasts shipping) to Jack are listed under the header line categories of week 1 through week 5. As such, Joan has shipped (or forecasts shipping) 500 pounds of beans in week 1, 350 pounds of beans in week 2, 400 pounds of beans in week 3, 500 pounds of beans in week 4, and 200 pounds of beans in week 5.

Text line 420 indicates that the community is FoodPlace, and the member involved is Food Lot. Trader Ken transacts business on behalf of Food Lot. The consumable involved in the transaction is Type A Beans. Further, the quantities of Type A Beans that Ken has shipped (or forecasts shipping) to Jack are listed under the header line categories of week 1 through week 5. As such, Ken has shipped (or forecasts shipping) 900 pounds of beans in week 1, 780 pounds of beans in week 2, 450 pounds of beans in week 3, 550 pounds of beans in week 4, and 900 pounds of beans in week 5.

The data in text lines 410, 415 and 420 can be transmitted by any of a number of individuals. For example, if the data in columns week 1 through week 5 represent actual deliveries made, the data may be transmitted to the data structure by a trader who is the shipping party, the receiving party, the carrier, etc. Further, if the data in columns week 1 through week 5 represent forecasted deliveries to be made, the data may be transmitted to the data structure by a trader who is the supplier, for example.

Text line 425 in FIG. 4 indicates the total quantity of Type A Beans that have been shipped (or are forecasted to be shipped) to Jack in each week by the aggregate of Jack's Type A Bean suppliers. Therefore, Jack has received (or is estimated to receive) 2400 pounds of beans in week 1, 1980 pounds of beans in week 2, 1750 pounds of beans in week 3, 1700 pounds of beans in week 4, and 1650 pounds of beans in week 5. As can be seen by this trend, the quantity of Type A beans being shipped to Jack during the five week time period is declining. Trending shipments is only one example of the countless business applications that can be utilized through collaborative planning objects. This trending data may be useful to Jack in making business decisions related to Type A Beans. Further, since each of the members that Jack purchases Type A Beans from is part of the FoodPlace community, all of the delivery data is provided automatically for Jack. Jack does not need to create a spreadsheet in order to track his receipts, and Jack does not need to manually update his receipt data in a spreadsheet.

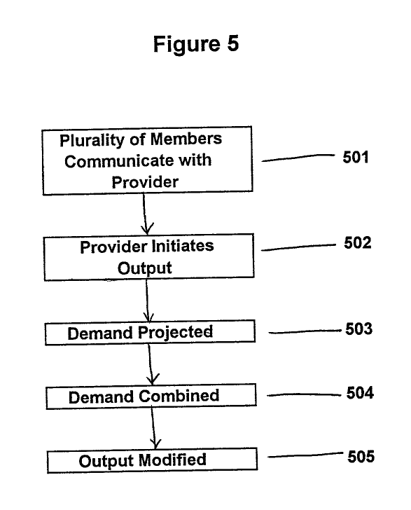

FIG. 5 is a flowchart which illustrates an exemplary embodiment of a process relating to a collaborative planning object. At step 501, a plurality of members communicate with a provider. For example, in a given community, there are a plurality of members, and each member is represented by one or more traders. In step 501, a provider may be a supplier of a product, who is a member of the community. Other members of the community purchase the product from the provider. The provider desires to plan the demand of each of his/her customers. Therefore, a trader, who transacts business on behalf of at least one of the members, supplies the provider with their respective forecasted demand for a given time period. If each member who purchases goods from the provider supplies their respective projected demand to the provider through a trader, then the provider is equipped to make business decisions related to the demand of the product.

In step 502 of FIG. 5, the provider initiates output of the product from the production process. At step 503, the provider is able to project the demand of each of the members, as each of the members have supplied their forecasted demand to the provider through a collaborative planning object. At step 504, the provider may desire to combine the demand of each of the members who require a given product in the given time period. By combining the demand of all of the members in the collaborative planning object, the provider is able to forecast an aggregate demand of all of the members. At step 505, the provider, now having a aggregate forecasted demand for all of the members through the collaborative planning object, can modify the output from the production process accordingly. The process outlined in FIG. 5 is only an example of how the process of creating and utilizing a collaborative planning object may be accomplished. The resource need not be a production schedule, but could be any of a number of resources such as an account listing, a delivery schedule, a manpower allocation schedule, or any other resource allocation or a planning type.

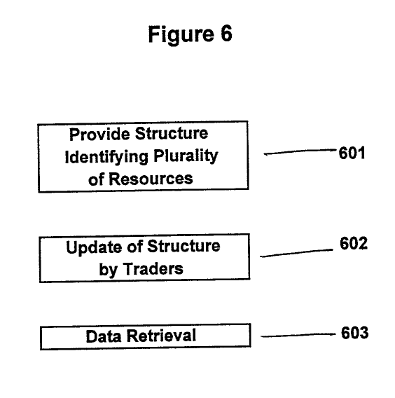

FIG. 6 is a another flowchart which illustrates an exemplary embodiment of the use of a collaborative planning object. At step 60 1, a data structure is provided which identifies a plurality of resources. The data structure could be a data structure which is used by numerous members within a community. Alternatively, the data structure could be for use between only two members of a community only. The data structure may be customized to the needs of the particular members involved in a transaction or series of transcations.

If the data structure provided in step 601 is for use by numerous members within a community, the data structure will be partitioned as needed to allow each member to transmit data to a certain area of the data structure. For example, a member may transact business through three traders. If each of the three traders are required to update their accounts within the data structure, the data structure may be partitioned such that each trader may only have access to their respective accounts.

In step 602, the data structure is updated by the traders. The updates required by each of the traders will depend upon the trader's function within the member's business. For example, a trader may update sales accounts, projected demand of a product, projected manpower demand, actual delivery schedules, projected delivery schedules, or any other resource allocation or planning type over the given time period. At step 603, the data which has been updated by the required traders is retrieved by the end user. For example, suppose a specific trader who transacts business for a provider member may be required to forecast demand for a given product. Each of the customers who purchases the given product may be required update their respective projected demand of the product. For example, a trader who is associated with each of the customer members may be required to update a data structure related to the collaborative planning object on a weekly basis. Then, at the end of the week, the provider member may retrieve the projected demand of each of the customer members (or an aggregate of the customer members) through the collaborative planning object.

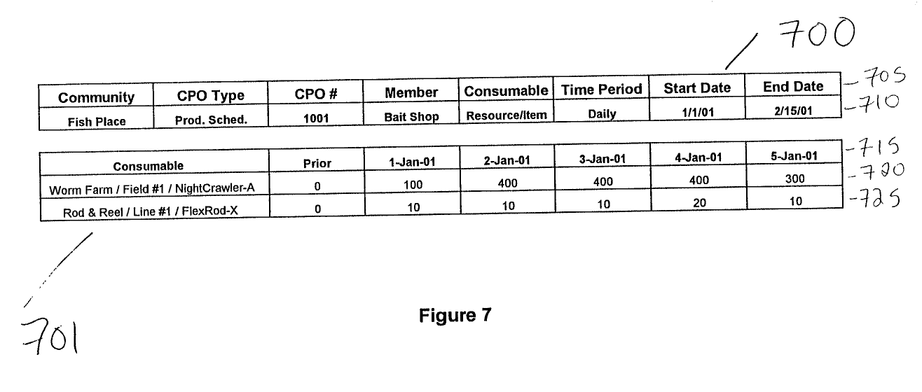

FIG. 7 provides a more detailed embodiment of the collaborative planning object. FIG. 7 includes the CPO definition 700, and the input data structure 701 associated with the CPO definition 700. The CPO definition 700 includes header line 705 and text line 710. Header line 705 provides the categories of information included in the collaborative planning object. Header line 705 categories include community, CPO type, CPO number, member, consumable, time period, start date and end date. Text line 710 provides that the community in which the collaborative planning object is being created is FishPlace. The CPO type is production schedule. As indicated above, a production schedule is only an example of a CPO type.

Text line 710 provides that the CPO number for this particular collaborative planning object is 1001. Each collaborative planning object is assigned a CPO number for identification purposes, as each member or trader may have numerous collaborative planning objects. Text line 710 further provides that the member that has control over this collaborative planning object is Bait Shop. The consumable type provided for by text line 710 is a resource/item. Therefore, the consumable that member Bait Shop wishes to track the production schedule for may be labeled as a resource or a item. The time period included in text line 710 is daily, which means that each business supplier of member Bait Shop is required to enter the daily production schedule of the applicable resource or item. The start date provided is Jan. 1, 2001, and the end date provided is Feb. 15, 2001. Therefore, the collaborative planning object provided by FIG. 7 is tracking the production schedule on a daily basis, for the time interval of Jan. 1, 2001 to Feb. 15, 2001.

FIG. 7 also includes the input data structure 701. Input data structure 701 includes header line 715, input data line 720 and input data line 725. Header line 715 includes the categories of data which are included in the input data structure 701. The categories included in header line 715 are consumable, prior balance, and a quantity entry for each date within the applicable time period. Text line 710 provided that the time period was daily from Jan. 1, 2001 though Feb. 15, 2001. However, header line 715 only appears to include the dates of Jan. 1, 2001, Jan. 2, 2001, Jan. 3, 2001 , Jan. 2, 2001, Jan. 3, 2001, Jan 4, 2001 and and Jan 5, 2001. Although the remaining dates from Jan. 6, 2001 through Feb. 15, 2001 are not shown, it is understood that they are intended to be included in header line 715.

Input data lines 720 and 725 include data related to the production schedules of certain products by members who supply goods to member Bait Shop. Input data line 720 is the production data connected with Worm Farm, a member of community FishPlace. In the consumable field, input data line 720 provides that the consumable is from member Worm Farm, and comes from resource Field #1, and the item is NightCrawler-A. This means that Worm Farm has a field in which it breeds nightcrawlers which is known as Field #1. Further, the nightcrawlers that are bred in Field #1 are type NightCrawler-A. Therefore, input data line 720 will indicate the production schedule for producing NightCrawler-A type nightcrawlers in Field #1, which belongs to member Worm Farm.

Input data line 720 indicates that the prior production balance of NightCrawler-A type nightcrawlers in Field #1 is zero, as the “prior” column shows a quantity of zero. However, input data line 720 indicates that the scheduled production of NightCrawler-A type nightcrawlers in Field #1 is 100 units for Jan. 1, 2001, 400 units for Jan. 3, 2001, 400 units for Jan. 3, 2001, 400 units for Jan. 4, 2001 and 300 units for Jan 5, 2001.

Input data line 725 is the production data connected with Rod & Reel, a member of community FishPlace. In the consumable field, input data line 725 provides that the consumable is from member Rod & Reel, and comes from resource Line #1, and the item is a FlexRod-X. This means that with Rod & Reel has a production line in which it manufacturers fishing rods which is known as Line #1. Further, the fishing rods that are manufactured are of a type called FlexRod-X. Therefore, input data line 725 will indicate the production schedule for producing FlexRod-X type fishing rods in Line #1, which belongs to member Rod & Reel.

Input data line 725 indicates that the prior production balance of FlexRod-X type fishing rods in Line #1 is zero, as the “prior” column shows a quantity of zero. However, input data line 725 indicates that the scheduled production of FlexRod-X type fishing rods in Line #1 is 10 units for Jan. 1, 2001, 10 units for Jan. 2, 2001, 10 units for Jan. 3, 2001, 20 units for Jan. 4, 2001 and 10 units for Jan. 5, 2001.

Therefore, as member Bait Shop has access to CPO #1001, Bait Shop can determine the production schedules of the critical resources that it purchases from member Worm Farm and member Rod & Reel. Accordingly, Bait Shop is provided with an efficient an accurate mechanism through which to plan future business decisions.

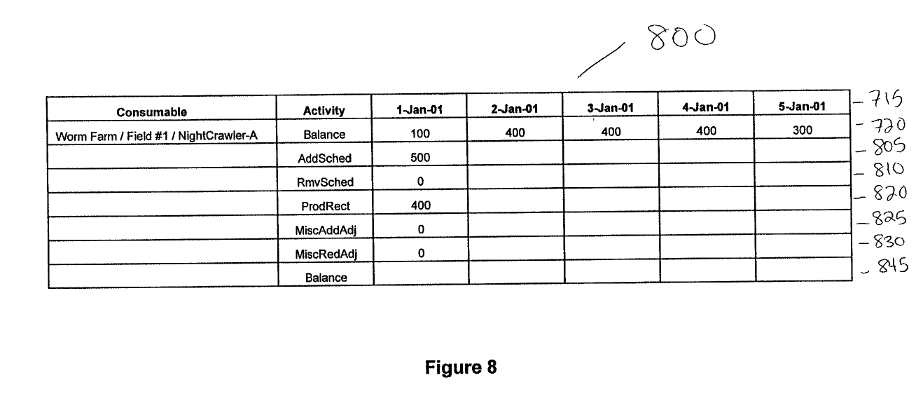

Additional information related to the each consumable may also be available. For example, FIG. 8 provides CPO activity balance 800 for the consumable NightCrawler-A type nightcrawlers from Field #1 of member Worm Farm. The CPO activity balance 800 includes the header line 715. As previously indicated, header line 715 includes the categories of data which are included in the input data structure 701. The categories included in header line 715 are consumable, prior balance, and a quantity entry for each date within the applicable time period. The CPO activity balance 800 also includes input data line 720 which provides that the consumable is from member Worm Farm, and comes from resource Field #1, and the item is NightCrawler-A. As indicated above, input data line 720 indicates that the production balance of NightCrawler-A type nightcrawlers in Field #1 is 100 units for Jan. 1, 2001, 400 units for Jan. 2, 2001, 400 units for Jan. 3, 2001, 400 units for Jan. 4, 2001 and 300 units for Jan. 5, 2001.

However, CPO activity balance 800 also provides activities that have affected, will affect, or may affect, the balance of the consumable on a given date within the applicable time period. In a collaborative planning object, any of a number of activities can be listed which impact the quantity balance of a resource on a given date. For example, when the CPO type is a production schedule, activities which may be included in the CPO activity balance include increase in production schedule (AddSched), decrease in production schedule (RmvSched), increase production activity (ProdRect), miscellaneous decrease in production activity (MiscRedAdj), miscellaneous increase in production activity (MiscAddAdj), etc.

CPO activity balance 800 includes activity field 805 (AddSched), 810 (RmvSched), 820 (ProdRect), 825 (MiscAddAdj), 830 (MiscRedAdj) and 845 (Balance). These are the activity fields that are included in the CPO activity balance 800 related to consumable Worm Farm/Field #1/NightCrawler-A. However, this is only an example of the activity fields that may be included in a CPO activity balance related to a consumable. A CPO activity balance may include any of a number of activity fields that are appropriate to the respective business transactions. As is shown in FIG. 8, entries have been made into activity field 805 (AddSched) and in activity field 820 (ProdRect). Activity field 805 (AddSched) includes an entry of 500 units on Jan. 1, 2001. This means that as of Jan. 1, 2001, there is an order to increase the production schedule by 500 units. Activity field 820 (ProdRect) includes an entry of 400 units on Jan. 1, 2001. This means that as of Jan. 1, 2001, there is an order to increase the production activity by 400 units.

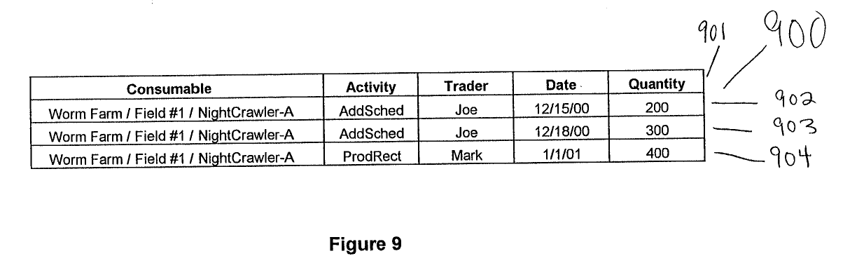

FIG. 9 provides additional information about each of the active entries included in any of the CPO activity fields (i.e. activity fields 805, 820). These additional details are included in CPO activity details structure 900. CPO activity details structure 900 includes header line 901. Header line 901 includes the categories of data which are included in the CPO activity details structure 900. The categories included in header line 901 are consumable, activity, trader, date and quantity.

As indicated above, CPO activity details structure 900 provides additional information about each of the active entries included in any of the CPO activity fields. Recall from FIG. 8 that activity fields 805 (AddSched) and 820 (ProdRect) included active entries. Therefore, CPO activity details structure 900 will provide additional details concerning each of these entries. Input lines 902 and 903 provide additional information relating to the active entry in activity field 805. Input line 904 provides additional information relating to the active entry in activity field 820.

Input line 902 provides that the consumable is NightCrawler-A type nightcrawlers, from member Worm Farm's Field #1. The activity provided is to increase the production schedule (AddSched). The trader associated with the order to increase the production schedule is Joe. The date of the activity order from Joe is Dec. 12, 2000. The quantity by which the production schedule is to be increased is 200 units.

Input line 903 provides that the consumable is NightCrawler-A type nightcrawlers, from member Worm Farm's Field #1. The activity provided is to increase the production schedule (AddSched). The trader associated with the order to increase the production schedule is Joe. The date of the activity order from Joe is Dec. 18, 2000. The quantity by which the production schedule is to be increased is 300 units.

Recall from FIG. 8 that activity field 805 (AddSched) included an entry to increase the production schedule by 500 units, as of Jan. 1, 2001. Therefore, the increase included in input line 902 (200 units) and in input line 903 (300 units) have been aggregated into activity field 805 (500 units). This means that the orders to increase the production schedule on Feb. 15, 2000 (input line 902-200 units) and the order to increase the production schedule on Dec. 18, 2000 (input line 903-300 units) are both still active on Jan. 1, 2001, in activity field 805.

Input line 904 provides that the consumable is NightCrawler-A type nightcrawlers, from member Worm Farm's Field #1. The activity provided is to increase production activity (ProdRect). The trader associated with the order to increase production activity is Mark. The date of the activity order from Mark is Jan. 1, 2001. The quantity by which the production activity is to be increased is 400 units. Recall from FIG. 8 that activity field 820 (ProdRect) included an entry to increase the production activity by 400 units, as of Jan. 1, 2001. The details associated with the order to increase the production activity by 400 units is included in input line 904.

By utilizing the collaborative planning object, members of a community are able to effectively track any number of critical business planning types over any number of planning intervals. As such, a company that is a member within a metaprise community does not need to manually track critical business data and manually create and update spreadsheets in order to manage their supply and demand of critical resources.

While preferred embodiments of the invention have been shown and described herein, it will be understood that such embodiments are provided by way of example only. Numerous variations, changes and substitutions will occur to those skilled in the art without departing from the spirit of the invention. Accordingly, it is intended that the appended claims cover all such variations as fall within the spirit and scope of the invention.

What is claimed:

1. A method of managing output, said method comprising the steps of:
permitting a plurality of members to communicate with a further member which is a provider;
initiating, by a plurality of traders, output by said provider;
projecting demand of said members;
combining demand projected by said members; and
modifying output by said provider based on combined projected demand.

2. A method of planning a business objective, said method including the steps of:
providing a structure which identifies a plurality of resources, said structure relating a quantity of at least one of said resources to a period of time;
permitting a plurality of traders to have access to a portion of said structure, each of said traders belonging to at least one of a plurality of members, each of said members belonging to at least one of a plurality of communities; and
retrieving data which relates to said structure.

3. A method of managing output, said method comprising the steps of:
providing a demand structure for use by a provider to determine an output requirement, said provider being a member belonging to a community;
communicating with said provider by updating a portion of said demand structure, such that each of a plurality of members transmits data relative to a respective demand for a specified period of time to said demand structure; and
retrieving data from said demand structure such that said provider can determine said output requirement for a time interval.

4. A method of planning a business objective, said method including the steps of:
permitting a plurality of traders to update a portion of a structure which identifies a plurality of resources, said structure relating a quantity of at least one of said resources to a period of time;
initiating an output of at least one of said resources based on said updated structure;
projecting a demand of said plurality of said resources for each of said plurality of traders based on said updated structure;
combining said demand of each of said plurality of traders based on said updated structure; and
modifying said output of at least one of said resources based on said combined demand.

5. A method of managing output, said method comprising the steps of:
permitting a first plurality of members to communicate with a second plurality of members, said second plurality of members being providers;
initiating, by a plurality of traders, output by said providers;
projecting demand of said first plurality of members;
combining demand projected by said first plurality of members; and
modifying output by said providers based on said combined projected demand.

6. A method of planning a business objective, said method including the steps of:
providing a structure which identifies a plurality of resources, said structure relating a quantity of at least one of said resources to a period of time, said structure being used by a plurality of providers to determine output requirements, said providers being members;
permitting a plurality of traders to have access to a portion of said structure, said traders updating said portion of said structure based on their supply requirements, each of said traders belonging to at least one of a plurality of members, each of said members belonging to at least one of a plurality of communities; and
retrieving data which relates to said structure by said plurality of providers.

7. The method of claim 1 wherein each of said plurality of members communicate with said provider by transmitting data relative to a respective projected demand to said provider.

8. The method of claim 1 wherein said demand of said members is selected from the group consisting of production demand, payment demand, personnel demand, shipping demand and sales demand.

9. The method of claim 1 wherein said output is selected from the group consisting of product output, payment output, personnel output, shipping output and sales output.

10. The method of claim 2 wherein said plurality of resources includes at least one of production resources, payment resources, personnel resources, shipping resources and sales resources.

11. The method of claim 2 wherein each of said plurality of traders updates a respective portion of said structure to include a respective supply of said at least one of said plurality of resources.

12. The method of claim 2 wherein each of said plurality of traders updates a respective portion of said structure to include a respective demand of said at least one of said plurality of resources.

13. The method of claim 2 wherein said portion of said structure that each of said plurality of traders is given access to is related to an identity of each of said plurality of traders.

14. The method of claim 3 wherein said demand of said members is selected from the group consisting of production demand, payment demand, personnel demand, shipping demand and sales demand.

15. The method of claim 3 wherein said output is selected from the group consisting of product output, payment output, personnel output, shipping output and sales output.

16. The method of claim 3 wherein said specified period of time is equivalent to said time interval.

17. The method of claim 4 wherein said plurality of resources includes at least one of production resources, payment resources, personnel resources, shipping resources and sales resources.

18. The method of claim 4 wherein each of said plurality of traders updates a respective portion of said structure to include a respective supply of said at least one of said plurality of resources.

19. The method of claim 4 wherein each of said plurality of traders updates a respective portion of said structure to include a respective demand of said at least one of said plurality of resources.

20. The method of claim 4 wherein said portion of said structure that each of said plurality of traders is permitted to update is related to an identity of each of said plurality of traders.

21. The method of claim 5 wherein each of said plurality of members communicates with said plurality of providers by transmitting a respective projected demand to at least one of said plurality of providers.

22. The method of claim 5 wherein said demand of said members is selected from the group consisting of production demand, payment demand, personnel demand, shipping demand and sales demand.

23. The method of claim 5 wherein said output is selected from the group consisting of product output, payment output, personnel output, shipping output and sales output.

24. The method of claim 6 wherein said plurality of resources includes at least one of production resources, payment resources, personnel resources, shipping resources and sales resources.

25. The method of claim 6 wherein each of said plurality of traders updates a respective portion of said structure to include a respective supply of said at least one of said plurality of resources.

26. The method of claim 6 wherein each of said plurality of traders updates a respective portion of said structure to include a respective demand of said at least one of said plurality of resources.

27. The method of claim 6 wherein said portion of said structure that each of said plurality of traders is given access to is related to an identity of each of said plurality of traders.

28. An article of manufacture comprising a computer usable medium having computer readable program code means embodied therein for managing output, said computer readable program code means in said article of manufacture comprising computer readable program code means for causing a computer to effect:
permitting a plurality of members to communicate with a further member which is a provider;
initiating, by a plurality of traders, output by said provider;
projecting demand of said members;
combining demand projected by said members; and
modifying output by said provider based on combined projected demand.

29. An article of manufacture comprising a computer usable medium having computer readable program code means embodied therein for planning a business objective, said computer readable program code means in said article of manufacture comprising computer readable program code means for causing a computer to effect a method of completing said business objective, said method including the steps of:
providing a structure which identifies a plurality of resources, said structure relating a quantity of at least one of said resources to a period of time;
permitting a plurality of traders to have access to a portion of said structure, each of said traders belonging to at least one of a plurality of members, each of said members belonging to at least one of a plurality of communities; and
retrieving data which relates to said structure.

30. A computer program product comprising a computer usable medium having computer readable program code means embodied therein for managing output, said computer readable program code means in said computer program product comprising computer readable program code means for causing a computer to effect:
providing a structure which identifies a plurality of resources, said structure relating a quantity of at least one of said resources to a period of time;
permitting a plurality of traders to have access to a portion of said structure, each of said traders belonging to at least one of a plurality of members, each of said members belonging to at least one of a plurality of communities; and
retrieving data which relates to said structure.

31. A computer program product comprising a computer usable medium having computer readable program code means embodied therein for planning a business objective, said computer readable program code means in said computer program product comprising computer readable program code means for causing a computer to effect a method of completing said business objective, said method including the steps of:
providing a structure which identifies a plurality of resources, said structure relating a quantity of at least one of said resources to a period of time;
permitting a plurality of traders to have access to a portion of said structure, each of said traders belonging to at least one of a plurality of members, each of said members belonging to at least one of a plurality of communities; and
retrieving data which relates to said structure.

32. A data storage unit for managing output, said data storage unit comprising:
communication means by which a plurality of members communicate with a further member which is a provider;
output means by which said provider may initiate output;
projection means for projecting demand of said members; and
an arithmetic unit for combining demand of said members.

33. A data storage unit for managing output, said data storage unit comprising:
a data structure which identifies a plurality of resources, said structure relating a quantity of at least one of said resources to a period of time; and
communication means for permitting a plurality of traders to have access to a portion of said structure, each of said traders belonging to at least one of a plurality of members, each of said members belonging to at least one of a plurality of communities.

34. A data storage unit for managing output, said data storage unit comprising:
a demand structure for use by a provider to determine an output requirement, said provider being a member belonging to a community; and
communication means by which a plurality of members may update a portion of said demand structure, said portion of said demand structure relating a respective demand of each of said members to a specified period of time.

35. A data storage unit for managing output, said data storage unit comprising:
a data structure which identifies a plurality of resources, said data structure relating a quantity of at least one of said plurality of resources to a period of time, said data structure being partitioned into a plurality of portions such that a respective plurality of traders may update each of said portions;
output means by which output of at least one of said resources may be initiated;
projection means for projecting demand of said plurality of traders; and
arithmetic means for combining said demand of said plurality of traders.
